(19) United States
(12) Patent Application Publication
(10) Pub. No.: US 2014/0271925 A1
(43) Pub. Date: Sep. 18, 2014

(54) MODULATING SURFACE AND AEROSOL IODINE DISINFECTANT SYSTEM

(71) Applicant: NEET Innovations, LLC, Mount Airy, GA (US)

(72) Inventor: Terence F. MULLINS, Quebec (CA)

(73) Assignee: NEET Innovations, LLC, Mount Airy, GA (US)

(21) Appl. No.: 14/205,690

(22) Filed: Mar. 12, 2014

Related U.S. Application Data
(60) Provisional application No. 61/779,067, filed on Mar. 13, 2013.

(51) Int. Cl. A01N 59/12; B01F 15/04

(52) U.S. Cl. CPC A01N 59/12; B01F 15/0441
USPC 424/667; 366/152.2

(57) ABSTRACT

A method and apparatus for producing aqueous iodine solutions to be used as a surface and aerosol disinfectant under continuous and dynamic flow conditions for medical applications comprises dissolving iodine into a first water flow thereby producing a concentrated aqueous iodine solution. The iodine solution is stored and then blended with a second water flow to produce a predetermined iodine disinfectant concentration of aqueous iodine. The disinfectant concentration is then stored and chemically adjusted to polarize to the species of iodine. The disinfectant concentration is then thermodynamically adjusted to maximize retention and disinfection variables. The iodine disinfectant is then ready to be used in an application requiring disinfection using iodine.

This application claims priority under 35 USC 119(e) based on application No. 61/779,067, filed on Mar. 13, 2013.

### FIELD OF THE INVENTION

The present invention relates to the method of producing a concentrate of aqueous iodine, retaining said concentrate, reducing said concentrate, manipulating iodine species and controlling the retention of said iodine within the molecular water bond for use as general surface and aerosol disinfectant delivered through a humidification or spray system to control microbes in medical, industrial, agriculture and home environments.

### BACKGROUND OF THE INVENTION

Iodine is currently used as a disinfectant in hospitals. Iodine is well recognized as world class disinfectant used against bacteria and viruses which constitute a major health risk to humans. Medical facilities due to their nature often propagate the proliferation of disease among both healthy and sick individuals.

The vectors for the transmission of disease within medical establishments are mainly air-borne and surface borne. Post operative infections are a common occurrence that cause pain and undue suffering for humans and create a cost increase in patient care and treatment in the 10 of millions of dollars annually. “Nosocomial Diseases” are a group infections acquired by a healthy person while visiting a hospital. Both the incidence and the cost of nosocomial diseases are on the rise.

Current air scrubber systems and filtration systems are not adequately controlling the microbiological loading being creating within a given medical environment. To date, no viable alternative has been found to address this growing concern.

The production of aqueous iodine solutions is well understood. However and under dynamic flow conditions, current technologies fail due changing water temperatures within the iodine bed and fluctuating dissolution rates caused by water channeling issues within the iodine bed.

Heating the primary water supply has been identified as a stabilizer in the dissolving of iodine crystals under dynamic flow conditions. This technology is described in U.S. Pat. Nos. 7,201,113, 6,139,731, 6,120,812, 5,919,374, 5,853,574, and 5,792,371, which are herein incorporated by reference in their entirety. The problems with this approach occur not during operation but when the system is dormant and or between operations. That is, exterior environmental temperatures change the iodine solution temperature and thereby the concentration within the cylinder. The systems then fails because it does not recognize this problem and relies only on temperature to determine iodine concentration. For example, if a known concentration is produced based on a given temperature and then the iodine bed sits dormant, the iodine concentration will change based on ambient or other external heat sources. If the temperature is then reduced in said iodine bed, the concentration will remain at its most concentrated level. So, temperature cannot be used as an indicator of iodine concentration within a solution or an iodine bed.

Iodophor/povodone are the current iodine technologies used in hospitals. The only active biocide is iodine with these technologies. By design, their molecular structures utilize materials within the matrices that are not suitable for human consumption or inhalation. Plastics, surfactants, and acids are among the inert materials.

It is also well understood that at low pH levels below (below 8), elemental iodine is the dominant species of iodine and is a superior biocide. On the other hand, hypoiodous acid, which is present at high pH levels (above 8) is the dominant species of iodine and a superior virucide. However, the manner of delivery of these products can affect their disinfection capabilities.

Aqueous iodine to date has not been utilized as a disinfectant through a humidification/spray system due to several factors including: surface retention and contact time of the disinfectant, premature release of the molecular iodine bonding with the carrier molecule, location and design of the humidification spray system and the inability to accurately deliver a known concentration of aqueous iodine therefore producing a known reconstituted iodine disinfectant concentration.

The present invention addresses and surmounts the hereinabove debilitating factors for delivery applications employing aqueous iodine as a disinfectant.

### SUMMARY OF THE INVENTION

It is object of this present invention to provide an apparatus and method for producing iodine disinfectants that can be delivered through humidification/spray systems to provide surface and air microbial control. The iodine species is manipulated to target specific airborne and surface borne bacteria and viruses. The invention provides for the modulation and blending of iodine species. The invention also provides for the control of the retention bond between the iodine species and the carrier water molecule.

It is further object of this invention to sense the concentration being generated and retained in a first stage and provide mechanical adjustments to the blend ratio into a second stream of water to ensure accuracy of disinfection.

It is further object of this invention to provide a sealed, insulated, iodine cylinder with interior diffusers to reduce or negate the possibility of water channeling through the iodine bed and reduce ambient heat interference when making an iodine concentrate. The diffusers redirect the water path and would typically be spherical in nature and either fabricated from glass or plastic. These diffusers could be either solid or perforated. The diffusers are sized to ensure they do not block the aperture of the incoming water supply into the iodine cylinder. The diffusers can be placed at varying locations with the iodine bed.

It is further object of this invention to provide a replaceable iodine cylinder when the initial cylinder in expended.

It is further object of this invention to provide variable disinfection rates and microbiological species targeting through a programmable controller.

Accordingly, this invention provides for the broadest aspect a method for producing target specific iodine species in order to harness and maximize the disinfection capabilities of iodine within a dynamic system.

Accordingly, this invention also provides for modulation capabilities of the iodine species and iodine concentration.

The present invention includes devices to monitor and control the production of the aqueous iodine concentrate, an apparatus to retain and manipulate the iodine chemistry and the thermodynamics of the iodine disinfectant.

The invention provides for a safe, controlled broad band microbial aqueous iodine disinfectant that can be modulated to enhance efficacy.

In one mode, a method of providing a disinfecting spray using iodine comprises:
a) passing a water flow through an iodine cylinder to produce a definable saturate of iodine;
b) retaining a determined volume of aqueous iodine concentrate in, for example, a tank;
c) diminution blending of the iodine concentrates with a secondary water flow to produce a known volume of aqueous iodine disinfectant into different holding chambers;
d) chemically adjusting the retained known volume of the iodine disinfectant to polarize the iodine species in each chamber;
e) thermodynamically altering (heating or chilling) the retained known volume of the iodine disinfectant in each chamber; and
f) plumbing a desired solution into the humidification/spray system, wherein an electronic controller can make the necessary valve adjustments to introduce a pre-selected iodine disinfectant program to the humidification/spray system.

In an alternate embodiment, the iodine concentrate is produced remotely and delivered manually to the tank for supply to make the iodine in the chambers or the iodine concentrate can be fed directly to the secondary chambers if desired.

In yet another alternative embodiment, the speciation adjustment of the iodine can be made under dynamic flow conditions and not in the retention tanks.

In yet a further embodiment, the aqueous iodine concentrate can be injected in several locations.

The method thus can, under low flow or high flow dynamic conditions with intermittent dormant periods, readily and accurately provide a controlled iodine disinfectant supply to a humidification/spray system within a hospital establishment or other location requiring the use of the disinfectant.

The invention also entails an apparatus, which in one embodiment, can be described below.

One embodiment of the apparatus is for producing a known concentration of aqueous iodine that is then reconstituted and manipulated to maximize the microbial interaction and efficacy of said iodine disinfectant when delivered through a humidification/spray system. The apparatus comprises:
a) an iodine cylinder with screening and directional diffusers to facilitate and control the dissolution of the solid iodine;
b) means for providing and heating a first water flow;
c) mixing capabilities for affecting the dissolution of solid iodine with said first water flow to produce a concentrate of aqueous iodine;
d) mixing capabilities for the diminution of the aqueous iodine concentrate;
e) means for retaining and polarizing the species of iodine;
f) means for thermodynamically controlling the iodine disinfectant; and
g) the ability to connect the apparatus providing the iodine disinfectant into a humidifier/spray delivery system or other system that can use the disinfectant.

The apparatus can have the ability to sense and retain the iodine concentration produced, can institute concentration dilution metering changes as required within or without the retention system, can sense and manipulate the iodine species within or without the retention system, and can thermodynamically control the iodine disinfectant. The ability and means to perform these functions and those listed in (a-g) are described in more detail below.

The apparatus is especially adapted to interface with a humidification spray system, either as a newly-built one or one that already exists or can be retrofitted into an existing mechanical spray system.

The apparatus can also be used with a supply of the aqueous iodine concentrate rather than employ components to generate such a concentrate from solid iodine. The apparatus can also have the capability to both generate the aqueous iodine concentrate and receive an already produced aqueous iodine concentrate for making the diluted iodine solutions with their controlled species and concentrations for use in a disinfecting application.

Preferably, the apparatus described above can further comprise peristaltic or positive displacement pumps to move a first water supply through the iodine cylinder, a peristaltic or positive displacement pump to move the iodine concentrate either generated and stored in a tank or received from an external source for blending with a second water supply to produce a known iodine disinfectant concentration to be housed in retention tanks or chambers. Electronic valves located on the retention tanks can provide the iodine disinfectant to the humidification/spray system. Peristaltic pumps or other controls can be employed to control the pH of the iodine disinfectant.

The apparatus can preferably include the following components to produce the desired disinfectant for use as desired:
A) a temperature sensor to detect the first water flow;
B) a sealed insulated PVC plastic iodine cylinder with diffusers;
C) a heating system to detect and control the temperature of the first water supply;
D) an oxygen reduction potential meter/or a halogen analyzer test system to electronically detect the iodine solution concentration;
E) a pump to blend the concentrated iodine solution into the second supply of water thereby producing a known aqueous iodine disinfectant concentration that is to be retained within or without the system;
F) a pump and chemical (carbonate/bicarbonates) to adjust the pH and therefore the species of the retained iodine disinfectant;
G) a typical 5 gpm water chiller/immersion chiller rod or a low watt immersion probe heating system to chill or heat the retained iodine disinfectant;
H) a plumbing connection controlled by solenoid valves, for example, to the water feed supply of an existing mechanical humidification/spray device.
I) a programmable controller that collects data on the operation of the system, wherein the programmable controller that can remotely access data produced by the system and includes interactive displays and built in safety limits.

The present invention targets and addresses the current problems with microbiological control within hospitals and medical establishments. The invention provides the broadest spectrum of iodine microbial control within the general disinfectant marketplace. This invention safely provides both and aerosol disinfectant to kill airborne disease and a surface disinfectant that can be applied on a continuous or intermittent basis to manage or eradicate harmful pathogens specifically bacteria and viruses.

The present invention provides for a myriad of iodine species configurations, retention times within the iodinated mist water and disinfection treatment levels, for example ranging from 0.25 ppm to 600 ppm aqueous iodine, preferably 0.25 to 100 ppm.

The present apparatus as hereinabove described may be used in other applications that do not involve a humidification or spray system. This invention provides a known broad spectrum aqueous iodine disinfectant that can be used in medical, pharmaceutical, agricultural applications, poultry and egg treatment, food processing, ice, hand washes, dental offices, and the like.

Other applications that can employ the iodine disinfectant produced by the invention include providing controlled aqueous iodine solutions for the ocean industries to control zebra mussel's migration and other ballast water microbes, micronutrient applications for human, animal and plant development, inhalation or injection of aqueous iodine for the reduction of tumors and other diseases in humans, and treatment for iodine deficiency in humans.

Accordingly, in further aspect the invention provides iodine species that are contained in an aqueous state, prepared according to the invention as hereinabove defined for use in the aforesaid applications.

### BRIEF DESCRIPTION OF DRAWINGS

FIG. 1 represents a schematic flow diagram of one embodiment of the method and apparatus according to the invention.

FIG. 2 represents a flow diagram showing an alternative method and apparatus according to the invention.

FIG. 3 represents a further embodiment of the inventive method and apparatus.

### DETAILED DESCRIPTION OF THE INVENTION

One embodiment of the invention is described in FIG. 1. This Figure shows an apparatus to produce an iodine disinfectant for use in any number of applications, including a humidification/spray system. FIG. 1 also describes the methodology of producing the iodine disinfectant and the overall system is designated by the reference numeral 950. FIG. 1 shows the embodiment wherein an iodine concentrate is made and then further modified into a number of solutions of different iodine concentrations. These different solutions are then controlled in terms of pH, etc. so that they are ready for use in an application appropriate for the particular type of iodine disinfectant prepared. Applications include a humidification/spray system of a hospital to provide a surface and aerosol disinfectant in operating rooms, post operating rooms, intensive care, trauma centers, clinics, and other areas where surface disinfection and air quality pose a health risk. Other uses of the surface and aerosol iodine disinfectant for example are cruise ships, airplanes, trains, office buildings, apartment buildings, food processing facilities, restaurants, schools, and nursing homes.

With reference to FIG. 1, a source of water or water supply is available and designated by reference numeral 301. Water from the water supply 301 is proportioned through a pump 400 into water heater (100). The water supply is typically a potable water or distilled. The temperature of the source water is sensed by way of a thermocouple 303. The water is then heated in the heater 100 to approximately 80 degrees ° F. and passed through an iodine cylinder 500 to create a saturate of aqueous iodine, e.g., 250 to 300 ppm or up to 600 ppm. Reference numeral 300 shows the water flow direction from the source 301 as well as to other components of the system as detailed below.

The iodine cylinder 500 is fabricated from an iodine inert material, e.g., PVC plastic, designed with directional diffusers that enhance the dissolution of the iodine crystals. The aqueous iodine saturate is contained in a retention tank 600. The aqueous iodine solution is transferred to a retention tank 600 and is then monitored for iodine concentration by an apparatus, e.g., an oxygen reduction potential meter or an online analyzer test system 55.

The iodine saturate in retention tank 600 is blended with water from the water supply 301 using a pump 401 to reduce the saturate to a desired disinfectant concentration. This diluted saturate is then pumped via pump 401 to one or more of a plurality of disinfection tanks 620B-620E.

A flow meter 775 is provided in conjunction with the pump 401. The flow meter 775 enables an accurate production of a desired disinfectant by proportionately blending the source water from supply 301 and the aqueous iodine concentrate from tank 600.

A typical pH control system, 400 representing the system and 800 representing the ability to control the pH in the tanks 620B-E, with pumps (not shown) and pH adjustment chemicals to target pH levels, e.g., a ph of 7 or less in tank 620B and 620D and a pH level of 8.5 or greater in tanks 620C and 620E.

The disinfection tanks 620B-E are fed using a valve 301V, preferably a solenoid valve, and pump 401 with iodine disinfectant. For disinfection tank 620B, the disinfectant fed to the tank 620B is further controlled using valve 320BL, which can also be a solenoid valve. The disinfectant being fed to tank 620B can be cooled by a water chiller system 700 and pH adjusted to 6.5 using the pH adjustment system 400/800 to polarize the elemental species of iodine within the disinfectant.

Disinfection tank 620C is loaded through another valve 320CL with iodine disinfection, is then cooled using chiller 700 and pH adjusted using the pH system and control 400/800 to 8.5 to polarize the hypoiodous acid species within the disinfectant.

Disinfection tank 620D is loaded through yet another valve 320DL with iodine disinfectant and is then heated using a heater 100 and pH adjusted using the pH system and control 400/800 to 6.5 to polarize the elemental species of iodine within the iodine disinfectant.

Disinfectant tank 620E is loaded through another valve 320EL with iodine disinfectant and is then heated using the heater 100 and pH adjusted using the pH system and control 400/800 to 8.5 to polarize the hypoiodous acid species of the iodine disinfectant.

With each of the tanks 620B to 620 E loaded with a disinfectant of specific iodine concentration and species, the system is now ready to dispense one or more of the disinfectant solutions for a desired use.

The system and method also uses an electronic controller 900 and its use in the system and method is now described. This controller 900 is programmable and receives inputs from multiple sensors (not shown) within the system. Sensors in retention tank 600 enable starting pump 400 to meter a supply of water from source 301 through heater (100) to heat the water to less than 80 degrees ° C. The water then passes through iodine cylinder 500 and produces a saturate of aqueous iodine which then fills retention tank 600.

Level sensors (now shown) are provided in the tanks 620B-620E and provide a signal to the controller to fill. Solenoid valve 301V opens and water from supply 301 begins to flow. Flow sensor 775 sends a signal to the controller for pump 401 to proportionally blend iodine from retention tank 600 with water from supply 301 to create a pre-selected disinfection concentration of aqueous iodine to be provided to disinfection tanks 620B-E via the valves 320BL-320EL.

Once the disinfection tanks 620B-E are filled, the controller closes solenoid valves (320BL to 320EL at the inlet of the tanks 620B-E). Based on the particular program selected by the controller, water temperature and pH is sensed and adjusted in each tank individually.

When using the disinfectant solution for air borne or surface treatment, the disinfection tanks 620B-E can be connected directly into the feed supply of the humidification/spray system and using solenoid valves (320Bu-Eu), which are located at an outlet of the tanks 620B-E. These valves 320Bu-Eu are also operated by the controller (900). The controller (900) can modulate the programming of the valves (320Bu-Eu) and provides for a vast variety of disinfection capabilities at the outlet 330. This would include using just one of the tanks 620B-E as a supply for disinfection or combining the solutions in one or more of the tanks 620B-E as the supply for a desired disinfecting application.

As noted above, the disinfectant solution 330 can be used in any of the applications noted above as well as others that require disinfection where iodine is the appropriate disinfecting agent.

The system 950 also includes a shut off valve 325. The shut off valve 325 isolates the outlets of the tanks. The shut off valve can also serve as a source of dilution water if the iodine solutions in the tanks 620B-E need to be further diluted 620B-E from the water supply. That is, the tank 600 can have a concentration of up to 600 ppm iodine and this saturate could be pumped to one or more of the tanks 620B-E. This saturate could then be diluted by opening valve 325 and providing source water in this way.

The water source 301 can be filtered prior to its use with the inventive apparatus. Any filtering can be used, with a preferred filtering being a reverse osmosis system. The filter is designated by reference numeral 304 in FIG. 1.

The apparatus provides a means for creating a second iodine solution in each tank, wherein the second iodine solution has a predetermined concentration of iodine and a predetermined iodine species in the tanks 620B-E. This includes the ability to dilute the iodine concentrate, whether made or supplied from an external source, using the supply water and control the pH and temperature of the diluted solution for ultimate use in a disinfecting application, e.g., the pH control system 400/800 and heater 100 and chiller 700.

The apparatus also includes means for making one or more of the second iodine solutions of a desired iodine concentration and desired iodine species from the plurality of tanks 620B-E available for use in an application needing the desired iodine concentration and iodine species. This means includes the controller 900 and the outlet valves of the tanks 620B-E since the controller is able to make the desired species and concentration in each of the tanks 620B-E by temperature and pH adjustment and further control the flow of the second iodine solutions to provide one or more for desired applications, e.g., a spray/humidification system or any other application that can use one or more of the second iodine solutions).

The apparatus also includes means for creating a first iodine solution from the solid iodine, e.g., the diffuser-containing iodine cylinder adapted to receive temperature-controlled water, a tank for receiving and storing of the first iodine solution, and a system to monitor the iodine concentration in the tank.

FIG. 2 shows an alternative system and methodology of the invention and is designated by the reference numeral 960. In this embodiment, the capability of producing the concentrated iodine solution for later dilution for tanks 620B-620E is not included. Instead, the iodine concentration retention tank 600 is filled with a concentrate of aqueous by an external source. In this mode, the tank 600 and its connection to the line 601 feeding the tanks 620B-E is made so that the tank 600 can be easily removed and replaced with another tank loaded with the desired iodine solution, e.g., a quick connect coupling.

FIG. 3 shows yet another system and method of the invention that is designated by reference numeral 970. This embodiment puts the concentrated iodine solution making components on the back end of the tanks 620B-E rather than upstream as shown in FIGS. 1 and 2. Put another way, a feed water is prepared and then mixed on the fly with the iodine saturate for immediate use in a given application. Thus, the iodine saturate is proportionately blended directly into the prepared source water to produce the feed water for a humidification system or the like

In this embodiment, the iodine saturate providing means is designated by the number 750 and includes the same features as shown in FIG. 1 for making the iodine saturate from the supply water 301. In FIG. 3, the supply water for iodine saturate manufacture can be provided via line 715. Also and in accordance with FIG. 2, the ready made iodine saturate tank can be used with the appropriate pumps, etc. for supply of the saturate to the pH and temperature adjusted feed water from tanks 620B-E.

In this embodiment, the tanks 620B-E are controlled in terms of temperature and pH to produce to become an adjusted feed water supply. This adjusted feed water supply 340, which is controlled using flow meter and totalizer 775 is then combined with the appropriate amount of iodine solution from the outlet 324 from the tank 600 as an output 345, which can be delivered to a humidification/spray system. Since these humidification and spray system are well known, a detailed description of these systems is not necessary for understanding of the invention.

As such, an invention has been disclosed in terms of preferred embodiments thereof which fulfills each and every one of the objects of the present invention as set forth above and provides a new and improved apparatus and method for supply iodine in a disinfecting solution for use in various applications needing disinfection using iodine.

Of course, various changes, modifications and alterations from the teachings of the present invention may be contemplated by those skilled in the art without departing from the intended spirit and scope thereof. It is intended that the present invention only be limited by the terms of the appended claim.

I claim:

1. A method of providing a plurality of iodine solutions, each having a predetermined concentration of iodine and a predetermined iodine species comprising:
a) providing a source of a first iodine solution,
b) diluting the first iodine solution to create a plurality of second iodine solutions and treating each of the second iodine solutions to create a final iodine solution having a predetermined iodine concentration and iodine species, wherein one or more of the final iodine solutions having a desired concentration and iodine species among the plurality of final iodine solutions is made available for use in an application requiring a particular iodine concentration and iodine species.

2. The method of claim 1, wherein the predetermined iodine concentration can be varied for each final iodine solution.

3. The method of claim 1, wherein the final iodine solution is made available to a humidification and/or spraying system.

4. The method of claim 1, wherein the iodine concentration of the final iodine solution ranges from 0.25 to 600 ppm, preferably 0.25 to 100 ppm.

5. The method of claim 1, wherein the iodine species include elemental iodine and hypoiodous acid.

6. The method of claim 1, wherein the first iodine solution is provided from an external source.

7. The method of claim 1, wherein the first iodine solution is produced using solid iodine.

8. The method of claim 1, wherein two or more of the final iodine solutions are mixed and made available for said use.

9. An apparatus for providing a plurality of iodine solutions, each having a predetermined concentration of iodine and iodine species comprising:
a) a plurality of tanks capable of receiving a first iodine solution;
b) means for creating a second iodine solution in each tank, wherein the second iodine solution has a predetermined concentration of iodine and a predetermined iodine species and
c) mean for making one or more of the second iodine solutions of a desired iodine concentration and desired iodine species available for use in an application needing the desired iodine concentration and iodine species.

10. The apparatus of claim 9, wherein the creating means includes a heater and chiller for the plurality of tanks, a pH control system for adjusting the pH of the solutions in the plurality of tanks and for determining the species of iodine in each of the plurality of tanks.

11. The apparatus of claim 9, further comprising a tank for holding the first iodine solution and means for creating the first iodine solution from the solid iodine.

12. An apparatus for providing an iodine solution having a predetermined concentration of iodine comprising:
an iodine cylinder for holding iodine crystals, the iodine cylinder including diffusers therein to minimize water channeling in the iodine cylinder when water is pumped through the cylinder,
a storage tank for holding an iodine solution created by passing heated water through the iodine cylinder tank for holding the iodine solution; and
means for monitoring the iodine concentration in the storage tank so that the iodine solution can be made available for dilution and use in a disinfecting application.

13. A method of providing an iodine solution having a predetermined concentration of iodine for use in disinfection comprising:
a) providing a source of a solid iodine with diffusers,
b) passing water through the solid iodine and diffusers to create at least one iodine solution and monitoring the iodine concentration of the at least one iodine solution; and
c) making the iodine solution available for dilution and use in a disinfecting application.

14. A method of providing a plurality of iodine solutions, each having a predetermined concentration of iodine and a predetermined iodine species comprising:
a) providing a source of a concentrated iodine solution,
b) providing a plurality of feed water supplies that are adjusted in temperature and pH,
c) selecting at least one of the feed water supplies and combining it with the concentrated iodine solution to provide one of the plurality of iodine solutions having a predetermined iodine concentration and iodine species for use in an application requiring a particular iodine concentration and iodine species.

15. The method of claim 14, wherein the concentrated iodine solution is made by:
a) providing a source of a solid iodine with diffusers,
b) passing water through the solid iodine and diffusers to create at least one iodine solution and monitoring the iodine concentration of the at least one iodine solution; and
c) making the iodine solution available for dilution using one of the feed water supplies.

16. The method of claim 14, wherein the predetermined iodine concentration can be varied for each iodine solution.

17. The method of claim 14, wherein the iodine solution is made available to a humidification and/or spraying system.

18. The method of claim 14, wherein the iodine concentration of the iodine solution ranges from 0.25 to 600 ppm, preferably 0.25 to 100 ppm.

19. The method of claim 14, wherein the iodine species include elemental iodine and hypoiodous acid.

20. The method of claim 14, wherein the iodine solution is provided from an external source.

21. The method of claim 14, wherein two or more of the feed water supplies are used with the concentrated iodine solution.
